(19) United States
(12) Patent Application Publication
(10) Pub. No.: US 2025/0385469 A1
(43) Pub. Date: Dec. 18, 2025

(54) FLOATING CONNECTOR

(71) Applicant: ODU GmbH & Co. KG, Muehldorf a. Inn (DE)

(72) Inventor: Alfred Mitter, Muehldorf a. Inn (DE)

(21) Appl. No.: 19/238,584

(22) Filed: Jun. 16, 2025

(30) Foreign Application Priority Data
Jun. 18, 2024 (EP) 24182933.2
Dec. 30, 2024 (EP) 24223777.4

(51) Int. Cl. H01R 13/631

(52) U.S. Cl. CPC H01R 13/6315

(57) ABSTRACT

A floating electrical connector (1) comprising a mounting component (3) and a mating component (2) that is movable relatively to the mounting component (3). One component of the group of components comprising the mating component (2) and the mounting component (3) has a bearing (12) and at least one elastic biasing element (16). The other component of the group of components comprising the mating component (2) and the mounting component (3) has a floating ring (14) that extends into a gap between the biasing element(s) (16) and the bearing (12). The biasing element(s) (16) bias the floating ring (14) against the bearing (12). The biasing elements(s) (16) are tongue(s) fixed to the one component.

### CROSS REFERENCE TO RELATED APPLICATIONS

The present application claims priority of European patent application 24182933.2 filed on Jun. 18, 2024 and claims priority of European patent application 24223777.4 filed on Dec. 30, 2024. All the above are hereby incorporated by reference in their entirety.

### DESCRIPTION

### Field of the Invention

The invention relates to a floating electrical connector comprising a mounting component and a mating component that is movable relatively to the mounting component.

### Background of the Invention

From U.S. Pat. No. 10,892,576 B2, a floating electrical socket connector is known that includes a base and a barrel which is arranged inside a passageway of the base and can move within the base. The barrel includes a contact seated within the barrel, a wall, and a flange extending outwardly from the wall into a channel extending outwardly from the base's passageway. Two spring washers surround the wall at either side of the flange in the channel biasing the flange and engaging it with the base.

A connector similar to that of U.S. Pat. No. 10,892,576 B2 but with only one biasing washer is disclosed in US 2020/0313332 A1. The connector includes a generally cylindrical mounting base for receiving a contact element. A cylindrical side wall of the mounting base has an aperture for receiving the flange of the contact element such that the contact element can be laterally displaced in the aperture. A wave washer provided between a retainer and the flange biases the flange toward a flange of the base.

From EP 1 441 419 A2, a coaxial connector is known includes a base and a floating outer contact. A passage extends between a mounting end and a mating end of the base, and the mounting end is provided with an inwardly extending flange. The floating outer contact includes a mounting end with an outwardly extending flange that is trapped between the flange of the base and a circuit board onto which the connector is mounted. A spring washer between the lock washer of the floating outer contact and the mating end of the base exerts axial forces on the lock washer for urging the floating outer contact away from the circuit board thus forcing the inwardly extending flange of the base against the outwardly extending flange of the floating outer contact. An annular spring may be disposed between the flange of the base and the flange of the floating outer contact for countering the biasing forces exerted by the spring washer.

US 2020/0403343 A1 discloses another floating connector that has a generally cylindrical mounting base for receiving a contact element. A biasing element is disposed between the contact element and the base, which biasing element, however, is an annular array of spring member for biasing the contact element radially with respect to the base.

EP 2 878 041 B1 deals with a contact element that has an outer conductor and an inner conductor arranged within the outer conductor. On one of its longitudinal axial end surfaces, the outer conductor has at least one contact point for making contact with a contact point of a component which is to be contacted. In one embodiment, the end surface is a wave ring; in another embodiment the end surface is a contact ring with spring tabs arranged in an arc around a centre axis of the contact ring.

### OBJECT OF THE INVENTION

It is an object of the present invention to provide an improved floating electrical connector comprising a mounting component and a mating component that is movable relatively to the mounting component.

### Solution According to the Invention

In the following, any reference to one (including the articles “a” and “the”), two or another number of objects is, provided nothing else is expressly mentioned, meant to be understood as not excluding the presence of further such objects in the invention. The reference numerals in the patent claims are not meant to be limiting but merely serve to improve readability of the claims.

According to a first aspect of the invention, the problem is solved by a floating electrical connector with the features of claim 1. The floating connector comprising a mounting component and a mating component that is movable relatively to the mounting component. One component of the group of components comprising the mating component and the mounting component has a bearing and an elastic biasing element, while the other component of the group of components comprising the mating component and the mounting component has a floating ring that extends into a gap between the biasing element(s) and the bearing. The biasing element(s) bias the floating ring against the bearing. The biasing element(s) are fixed to the one component.

As used herein, the term “electrical connector” refers to any connector that can be mated with a matching connector to transmit electricity and/or electromagnetic signals. This does not exclude, however, that the connector in addition can transmit other modalities such as fluids or light.

In the context of the present invention, the term “mounting component” refers to a component of the connector that either can be mounted in or on an apparatus or a part of an apparatus to be provided with the connector or constitutes the apparatus or a part of the apparatus to be provided with the connector. Example for the apparatus or a part of the apparatus to be provided with the connector include a housing part, a conductor rail (also referred to as a power rail) or a circuit board. Moreover, the term “mating component” as used herein refers to the part of the connector that can be mated with a matching counter connector in order to establish a connection.

The term “floating connector” in the context of the present invention refers to the property of the connector that its mounting component can move relatively to the mating component. The term “floating ring” refers to the part of the other component on which the one component can float relatively to the other components, or with which the other component floats on the one component.

As used herein, the expression “one component” refers to one component of the group of components comprising the mating component and the mounting component. Accordingly, the present invention encompasses embodiments where the one component is the mating component as well as embodiments in which the one component is the mounting component. Moreover, in the context of the present invention the expression “other component” refers to the component of the group of components comprising the mating component and the mounting component that is not the one component. Accordingly, if the one component is the mating component, the other component is the mounting component and vice versa.

As used herein, the requirement that the biasing element(s) are “fixed” to the one component means that, directly or indirectly, they are rigidly connected to the one component, for example by welding (such as laser welding), soldering or glueing it to the one component, by positively of frictionally connecting—such as press-fitting, flanging, screwing or clamping—to the one component, or by being integral with the one component.

With the invention, the design of the floating connector can be simplified. In particular, it is achievable that a part of the one component to serve as a seat for the biasing element, such as a collar bolt, can be avoided. The simpler design can entail space savings due to a more compact design of the floating connector. It can also reduce manufacturing costs.

According to a second aspect of the invention, the problem is solved by a floating electrical connector with the features of claim 3. The floating electrical connector comprises a mounting component and a mating component that is movable relatively to the mounting component. One component of the group of components comprising the mating component and the mounting component has a bearing and at least one elastic biasing element. The other component of the group of components comprising the mating component and the mounting component has a floating ring that extends into a gap between the biasing element(s) and the bearing. The biasing element(s) are tongues that bias the floating ring against the bearing.

### PREFERRED EMBODIMENTS OF THE INVENTION

Preferred features of the invention which may be applied alone or in combination are discussed in the following and in the dependent claims.

In a preferred embodiment of the invention, the biasing element(s) press the floating ring against the bearing so that the floating ring touches the bearing with a biasing force exerted by the biasing element. Is it achievable that thereby an electrical contact can be established between the bearing, which is part of the one component, and the floating ring, which is part of the other component, so that electricity can flow between the mating component and the mounting component.

The biasing element(s) of a preferred floating connector are part of a biasing member. The preferred biasing member comprises a base plate with a base surface facing the floating ring. The preferred base plate is ring-shaped. The biasing element(s) preferably extend elastically outside the base surface towards the floating ring. Thereby, it is achievable that the biasing elements press against the floating ring elastically.

Preferably, there are at least two, more preferably more than two, for example 3, 4, 5, 6, 7, 8, 9 or more than 9 biasing elements. The preferred biasing elements press against the floating ring at different location of the floating ring. The locations in which the biasing elements press against the floating ring preferably are equidistant, for example arranged on a circle around a centre of the biasing member that comprises the biasing elements.

A preferred biasing element is a tongue that extend out of the biasing member's base surface to press on the floating ring. Preferred tongues are elastic, thereby providing the elasticity required for biasing the biasing element against the floating ring. More preferably, all biasing members are such tongues. Preferably, while one end of the biasing element's tongue is attached to the base plate, the other end of the tongue extends outside the base surface towards the floating ring.

The preferred base plate extends perpendicularly to the pressing-on direction in which the tongue presses against the floating ring. The longitudinal extension of a preferred tongue is slightly tilted with regard to the imaginary plane that is perpendicular to a pressing-on direction. The preferred tongue's longitudinal extension is in a circumferential direction of the biasing member. It is an achievable advantage of this embodiment of the invention that for the longitudinal extension of the tongue(s) part(s) of the circumference of the biasing member can be exploited, which circumference may be considerably greater than an exploitable width of the biasing member.

In a preferred embodiment of the invention, the biasing element comprises a press-on point for pressing on the floating ring or a press-on surface for pressing on the floating ring. Preferably, the press-on point is convexly domed or the edges of which press-on surfaces are convexly rounded or bevelled. Advantageously, with the convex press-on points or surface edges damage to the surface of the floating ring can be reduced or even avoided. Alternatively or in addition the preferred biasing element is a tongue with the free end of the tongue being rounded such that that the arc of the rounding extends in the surface of the tongue.

In a preferred embodiment of the invention at least one of the biasing element(s), more preferably all biasing element(s) are integral with the base plate. More preferably, the entire biasing member is a single integral part. With this embodiment, the manufacture of the biasing member can be simplified and its durability improved. For example, the combination of the biasing element(s) and the base plate, preferably the entire biasing member, can be formed from a sheet of material by one or a combination of the following methods: punching, stamping, cutting, deep-drawing, casting, moulding and milling.

The preferred base plate, comprising the biasing elements, is ring shaped, having an inner and an outer rim. The preferred outer rim has a circular, oval or rectangular cross-section. Likewise, the preferred inner rim has a circular, oval or rectangular cross-section.

The preferred biasing member comprises one or more reinforcements for stiffening the biasing member. More preferably in particular the base plate of the biasing member comprises one or more reinforcements for stiffening the biasing member. A preferred reinforcement is a corrugation, preferably formed by punching or stamping. In addition or in the alternative, reinforcements may be webs formed by casting, moulding or milling.

In some embodiments of the invention, the biasing member comprises a cylindrical collar. The preferred collar extends from the inner or the outer rim of the base plate. The preferred collar has a circular, oval or rectangular cross-section. Preferably, the collar is integral with the base plate. The combination of the base plate and the collar may, for example, be produced from a flat sheet of material, preferably metal, by means deep drawing.

In a preferred embodiment of the invention, the one component comprises a cylindrical or hollow cylindrical part, from which part the biasing member extends in radial direction. The preferred, preferably hollow, cylindrical part of the one component more specifically has a circular, oval or rectangular cross-section. The biasing member may either extend outwards from the outer surface of the, preferably hollow, cylinder, or, in the case of a hollow cylinder, it may, alternatively, extend inwards from the inner surface of the hollow cylinder.

The biasing member is fixedly attached to the one component, preferably the cylindrical part of the one component, at the inner or outer rim of the base plate. It may be attached for example by welding (such as laser welding), soldering or glueing, by positively of frictionally connecting—such as press-fitting, flanging, screwing or clamping—to the one component, or by being integral with the one component. Thereby the biasing elements are indirectly, via the base plate and in some embodiments via the collar, fixed to the one component. A preferred collar extends in or through the inside of the one component's cylindrical part.

If the collar is at the inner rim of the base plate or the base plate is attached to the one component at the inner rim of the base plate, the biasing element preferably are located at or near the other rim of the base plate. Conversely, if the collar is at the outer rim of the base plate or the base plate is attached to the one component at the outer rim of the base plate, the biasing element(s) preferably are located at or near the inner rim of the base plate.

Preferably the biasing member(s), particularly the entire biasing member are electrically conducting. Thereby, it can advantageously be achieved that by the biasing members electrically contacting the floating ring, electricity can be transported between the mating component and the mounting component. Particularly preferably, this is in addition to the electrical contact between the bearing and the floating ring, so that electricity can flow between the mating component and the mounting component via the biasing member as well as via the bearing. Advantageously, this can provide for a particularly reliable electrical connection between the mating component and the mounting component.

Similar to the one component, the preferred other component comprises a cylindrical or hollow cylindrical part, from which part the floating ring extends in radial direction and with which it preferably is integral. The preferred, preferably hollow, cylindrical part of the other component more specifically has a circular, oval or rectangular cross-section. The floating ring may either extend outwards from the outer surface of the, preferably hollow, cylinder, or, in the case of a hollow cylinder, it may, alternatively, extend inwards from the inner surface of the hollow cylinder. The floating rings surface that makes contact with the biasing element preferably extends in a direction perpendicular to the pressing-on direction in which the direction into which exerts its biasing force upon the floating ring.

The preferred biasing element presses the floating ring against the bearing in the pressing-on-direction. The preferred bearing comprises one or more point(s) or surface(s), in the following referred to as bearing points or bearing surfaces, with which it touches the surface of the floating ring that faces the bearing. Preferably, the bearing point(s) are convexly domed, or the edges of the bearing surface(s) are convexly rounded or bevelled. Thereby, advantageously, damage to the surface of the floating ring can be reduced or even avoided. A preferred bearing comprises a ring-shaped bearing surface, which inner and outer edges preferably are convexly rounded or bevelled to reduce or avoid damage to the floating ring.

The preferred floating ring more preferably the entire other component, is of copper, a copper alloy like for example brass or bronze, aluminium or an aluminium alloy. Preferably, at least the part(s) of the floating ring that touch the bearing or that touches the biasing element(s) are coated to have a top layer with silver (soft or hard), silver graphite, gold (soft or hard), tin, platin, rhodium, palladium or nickel. The invention also encompasses embodiments where the part(s) of the floating ring that touch the bearing or that touches the biasing element(s) are uncoated. The preferred bearing, more preferably the entire one component, is of copper, a copper alloy like for example brass or bronze, aluminium or an aluminium alloy. Preferably, at least at the bearing point(s) or bearing surface(s) of the bearing is coated to have top layer with silver (soft or hard), silver graphite, gold (soft or hard), tin, platin, rhodium, palladium or nickel. The invention also encompasses embodiments where bearing point(s) or bearing surface(s) are uncoated. The preferred biasing element(s), more preferably the entire biasing member, is of stainless steel or a copper alloy. Preferably, at least at the pressing-on point(s) or pressing-on surface(s) of the biasing element(s) is coated to have a top layer with silver (soft or hard), silver graphite, gold (soft or hard), tin, platin, rhodium, palladium or nickel. The invention also encompasses embodiments where the pressing-on point(s) or pressing-on surface(s) are uncoated.

The preferred bearing is ring-shaped and the ring's surface preferably extends in a plane that is perpendicular to the direction of the pressing-on force of the biasing element(s)'s. In some embodiments of the invention, the bearing is formed by a bearing flange that extends in a radial direction from a cylindrical or hollow cylindrical part of the one component and preferably is integral with this component. The preferred cylindrical part of the one component preferably is a hollow cylinder. Its cross-section preferably is circular, oval or rectangular cross-section. The flange may either extend outwards from the outer surface of the cylinder, or, in the case of a hollow cylinder, it may, alternatively, extend inwards from the inner surface of the hollow cylinder.

Preferably, if the biasing member extends outward from a part of the one component, the bearing likewise extends outward from a part of the one component, and conversely, if the biasing member extends inward from a part of the one component, so does the bearing. Also preferably, the biasing member and the bearing extend form the same part of the one component. Thereby a simple and compact design is achievable that provides between the biasing member and the bearing a space for the floating ring.

If the biasing member and the bearing extend outwardly form a part of the one component, the floating ring preferably extends inwardly from the other component and vice versa. This too allows for a simple and compact design. Preferably, a gap is provided between floating ring and the one component, for example by providing a significantly larger inner or outer diameter of the floating ring than the adjacent diameter of the one component, to ensure that floating ring can move relatively to the one component in plane that is essentially perpendicular to the pressing-on direction of the biasing element(s).

The preferred mating part has a contact part with mating direction that preferably is essentially perpendicular to a direction in which the mating part can be moved relatively to the mounting part. The mating direction preferably is aligned with the press-on direction of the biasing element(s).

The mating part can be male or female. The mating part may have a circular cross section or it may be elongate as for example in a flat female mating part disclosed in JP 2000182696 A or a male blade contact. It preferably comprises contacts for establishing an electrical contact with a matching counter connector when mated with the matching counter connector. Numerous examples for suitable male or female mating parts can be found, ia, in EP 3843219 A1. The contacts may for example be stamped from sheet metal, for example of the type offered a by ODU GmbH & Co KG under the brand name STAMPTAC®.

The preferred female mating part comprises an opening for accessing the contact(s), an inner rim of the opening preferably having a lead-in chamfer for the counter connector. Correspondingly, one or more contacts of a preferred male mating part have a lead-in chamfer at their outer leading edge.

The contact can be a contact sleeve, preferably a hollow cylindrical contact sleeve. The contact sleeve may employ as contact elements one or more springs such as the ones disclosed in DE 3 342 742 C2 or in EP 0 627 784 B1 or offered by ODU GmbH & Co KG under the brand name SPRINGTAC®. The contact sleeve may be not slotted or slotted as for example offered by ODU GmbH & Co KG under the brand name TURNTAC®, where parts of the sleeve between the slots can resiliently contact a corresponding contact element of a matching connector. Some or all of the slots typically extend in parallel to each other. The preferred male mating part is a contact pin that may be slotted or not slotted. Preferably, the sleeve or the pin is formed in integral with the inner circular cylinder.

The contact sleeve or pin may employ as a contact element a lamella comb as for example disclosed in EP 2015403 B1, EP 3641068 B1, EP 2209167 B1 or EP 3761455 A1 or offered by ODU GmbH & Co KG under the brand name LAMTAC®. In the context of the present invention, a “lamella comb” is an arrangement of more than two elastically resilient lamellae extending in the same general direction. The lamellae of the lamella comb can be joined with a matching contact pin or contact sleeve of a counter connector to establish an electrical contact between the lamella comb and a contact of the counter connector. For this purpose, the preferred lamellae of the lamella comb can be elastically deflected in a direction perpendicularly to a surface in which the lamella comb extends. This can allow the lamella to be elastically biased against contacts of the counter connector to provide for a reliable electrical contact.

A preferred lamella comb is a lamella basket. In the context of the present invention, a “lamella basket” is ring-shaped with the lamellae being arranged spaced from each other along the circumferential direction of the ring. Preferably, the lamellae of the lamella basket are extending perpendicularly to the circumferential direction of the ring. Preferably, the lamellae extend in mainly the direction of the symmetry axis of the ring and inwardly. They can preferably be elastically biased in radial direction against a contact of a counter connector.

Alternatively, the lamella comb extends along a straight line. Particularly preferably, the lamellae extend essentially in the direction perpendicular to the straight line. A preferred connector comprises at least two lamella combs of the kind in which the lamellae are arranged adjacent to each other along a straight line. Preferably, there is at least one pair of such lamella combs for contacting the same contact of the counter connector. The straight lines of the pair of lamella combs preferably lie within a common plane; particular preferably they extend in parallel to each other. Preferably, the lamellae of each comb of the pair of combs extend in mainly the direction perpendicularly to the common plane and towards the other one of the pair of combs. They can preferably be elastically biased against a contact of a counter connector inserted between the pair of lamella combs. Such pairs of lamella combs can be particularly suitable for contacts of counter connectors that have parallel flat side surfaces facing the lamella combs such as in the case of a contact blade. They can also be particularly suitable for contacting conductor base (also referred to as busbars).

The preferred lamella comb is one-sided in the sense that the lamellae at one end are fixed relatively to each other, which the other end is open, ie, free to move. Alternatively, the lamella comb can be two-sided in the sense that the lamellae at both ends are fixed relatively to each other. Ways of fixing the lamellae are for example disclosed in EP 2209167 A1, the relevant parts of which are herewith incorporated by reference into the present disclosure. For example, the fixed ends of the lamellae may join into a metal strip on one (one-sided) or both (two-sided) ends of the lamellae. Preferably, the lamellae are integral with the ring(s).

The lamella combs may be formed for example by stamping, cutting, deep drawing (as for example disclosed in EP 3761455 A1) or a combination of these methods.

A preferred mating part, particularly preferably a female male mating part, has a housing to enclose the contacts. The preferred cylindrical inner surface of the housing is a right cylinder. In some embodiments of the invention, a metal strip of a lamella comb is clamped between the housing and the inner circular cylinder.

The preferred mounting component has a mounting part for fixedly and conductively attaching the mounting part to a conductor rail or a circuit board. Particularly preferably, the mounting component has an essentially cylindrical mounting part, for example for mounting the mounting component in a hole of a conductor rail or a circuit board. The outer circumferential surface of the mounting part of the mounting component is at least partly corrugated, preferably knurled. Thereby, a secure fit of the mounting part can be achieved.

### BRIEF DESCRIPTION OF THE DRAWINGS

In the following, further preferred embodiments of invention are illustrated by means of examples. The invention is not limited to these examples, however.

The drawings schematically show:

FIG. 1A sectional side view of a first embodiment of the invention in which the biasing member is attached to the mating component by flanging and the mounting component has a cylindrical part;

FIG. 2 An oblique sectional side view of the embodiment of FIG. 1;

FIG. 3A sectional side view of a second embodiment of the invention similar to that of FIG. 1 but without the cylindrical part of the mounting component;

FIG. 4 An oblique sectional side view of the embodiment of FIG. 3;

FIG. 5 An oblique view of the biasing member of the embodiments of FIGS. 1 to 4;

FIG. 6A sectional side view of a third embodiment of the invention similar to that of FIG. 1 but with the biasing member being fixed to the mating component with a screw;

FIG. 7 An oblique sectional side view of the embodiment of FIG. 6;

FIG. 8A sectional side view of a fourth embodiment of the invention similar to that of FIG. 1 but with other dimensions;

FIG. 9 An oblique sectional side view of the embodiment of FIG. 8;

FIG. 10 An oblique view of the biasing member of the embodiments of FIGS. 8 and 9;

FIG. 11A sectional side view of a fifth embodiment of the invention similar to that of FIG. 1 but with the biasing member being welded to the mating component;

FIG. 12 An oblique sectional side view of the embodiment of FIG. 11;

FIG. 13A oblique sectional side view of a sixth embodiment of the invention similar to that of FIG. 1 but with the biasing member comprising a collar;

FIG. 14 An oblique view of the biasing member of the embodiments of FIG. 13;

FIG. 15A sectional side view of a seventh embodiment of the invention in which the biasing member is attached to a mounting component with a disk-like bearing;

FIG. 16 An oblique sectional side view of the embodiment of FIG. 15;

FIG. 17A sectional side view of the embodiment of FIG. 1 mounted in a conductor rail;

FIG. 18 An oblique view of the biasing member of the embodiments of FIGS. 15 and 16;

FIG. 19A sectional view of an eighth embodiment of the invention similar to that of FIGS. 15 and 16 but with an annular bearing;

FIG. 20 An oblique sectional side view of a nineth embodiment of the invention in which a conductor rail with a through hole servers as the mounting component;

FIG. 21A sectional side view of the embodiment of FIG. 20;

FIG. 22 An oblique sectional side view of a tenth embodiment of the invention in which the mating part is a short pin contact;

FIG. 23A sectional side view of the embodiment of FIG. 22;

FIG. 24 An oblique sectional side view of an eleventh embodiment of the invention in which the mating part is a slotted bushing for a pin contact;

FIG. 25A sectional side view of the embodiment of FIG. 24;

FIG. 26 An oblique sectional side view of a twelfth embodiment of the invention in which the mating part comprises a W-shaped lamella basket;

FIG. 27A sectional side view of the embodiment of FIG. 26;

FIG. 28 An oblique sectional side view of a twelfth embodiment of the invention in which the mating part comprises a U-shaped lamella basket;

FIG. 29A sectional side view of the embodiment of FIG. 28;

FIG. 30 An oblique sectional side view of a twelfth embodiment of the invention in which the mating part comprises flat bushing;

FIG. 31A sectional side view of the embodiment of FIG. 30;

### DETAILED DESCRIPTION OF AN EMBODIMENT OF THE INVENTION

In the following description of preferred embodiments of the invention, identical reference numerals refer to identical or similar components.

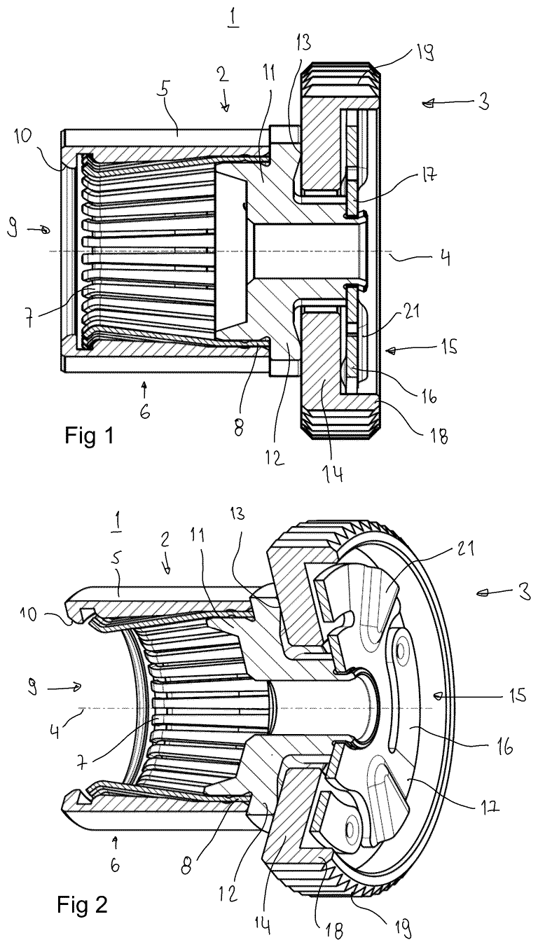

The floating electrical connector 1 shown in FIGS. 1 and 2 comprises a mating component 2 and a mounting component 3, which components, from the outside, are essentially circular cylindrical with a shared cylindrical axis 4 that extends in the mating direction of the mating component 2.

The mating component's 2 outer cylinder is hollow and forms the housing 5 of a mating part 6 of the mating component 2. Inside the housing 5, a one-sided lamella basket is provided that comprises numerous elastic metal lamellae 7 as contacts, the lamellae 7 extending from a ring-shaped metal strip 8 on one end of the cylindrical housing 5 towards the other end generally in the direction of the cylinder axis 4. As the lamellae 7 extend towards the other end of the housing 5, they are slightly inclined towards the cylindrical axis 4 so that when a matching male contact (not shown) is introduced into the female mating part 6, they can resiliently contact the male contact. On one end face of the cylindrical housing 5, an opening 9 is provided for accessing the lamellae 7, a rim of which has a lead-in chamfer 10 for the matching connector.

In modifications of this embodiment and the embodiments discussed further below, which modifications are not shown in the figures, instead of a female mating part, a male mating part, for example of the kind disclosed in EP 3843219 A1, is employed.

The mating component moreover comprises a hollow inner circular cylinder 11, the ring-shaped metal strip 8 being clamped between the outer wall of this inner cylinder 11 and the inner wall of the housing 5 that holds the lamella basket. The inner cylinder 11 forms a ring-shaped end face of the housing 5 opposite the housing's opening 9. Beyond this end face, a flange extends radially outwards from the inner cylinder 11 to form a bearing 12. A ring-shaped contact surface 13 of the bearing faces away from the mating part 6 towards a floating ring 14 of the mounting component 3.

Spaced apart from the bearing 12, a ring-shaped biasing member 15 is fixed to the mating component's 2 inner cylinder 11 and likewise extends radially from the latter. Biasing elements in the form of tongues 16 extend from a surface of a base plate 17 of the biasing member 15 into the space between the biasing member 15 and the bearing 12 to press on the mounting component's 3 floating ring 14 present in this space. At the location where the biasing member 15 is attached to the inner cylinder 11 of the mating component 2, the outer diameter of the inner cylinder 11 is reduced, thus producing a ring-shaped step on which the side of the biasing member 15 that faces the floating ring 14 sits. On the other side of the biasing member 15, the inner cylinder 11 is flanged outward to securely fix the biasing member 15 to the inner cylinder 11 of the mating component 2.

The mounting component's 3 floating ring 14 encircles the inner cylinder 11 of the mating component 2. The inner diameter of the floating ring 14 is significantly larger than the other diameter of inner cylinder 11 of the mating component 2 to ensure that floating ring 14 can move relatively to the mating component 2 in a plane that extends perpendicularly to the mating component's 2 symmetry axis 4. The floating ring's 14 outer diameter leads into and is integral with a cylindrical part 18 of the mounting part 3, which cylinder 18 is hollow, extends from the floating ring 14 towards the end of the connector 1 opposite the mating part 2, and is open towards this end of the connector 1. The cylinder 18 encloses the biasing member 15 at its sides. The outer surface 19 of the cylinder 18 is knurled to provide for a secure fit of the mounting part when placed in a matching hole of a conductor rail 20 or a circuit board.

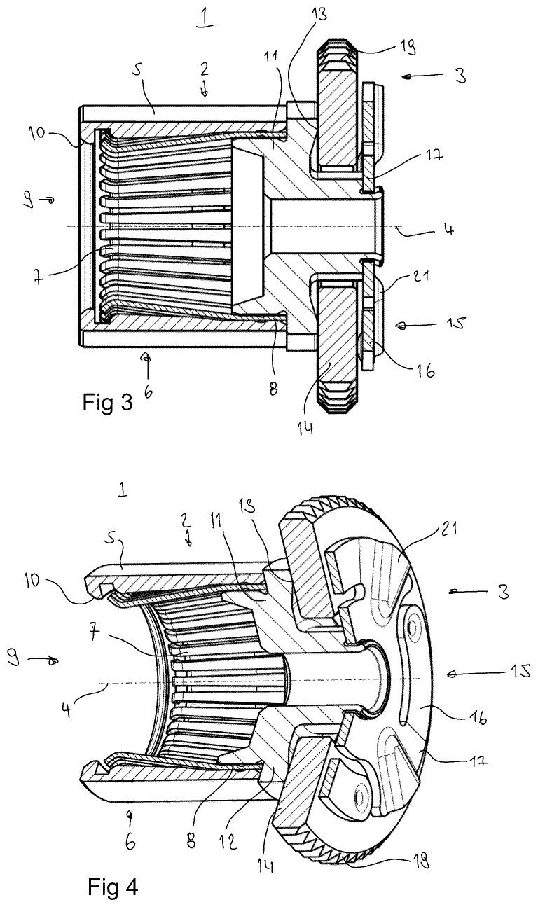

A variant of the connector 1 of FIGS. 1 and 2 is shown in FIGS. 3 and 4. It differs from the former variant only in that the mounting part 3 lacks an outer cylinder 18. Instead, the knurling is applied to the outer edge of the floating ring 14.

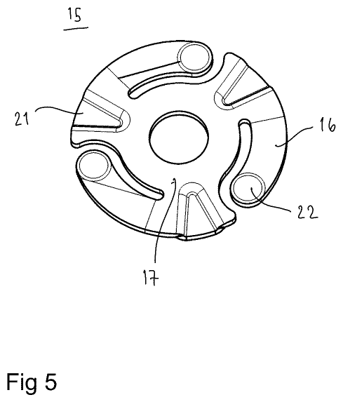

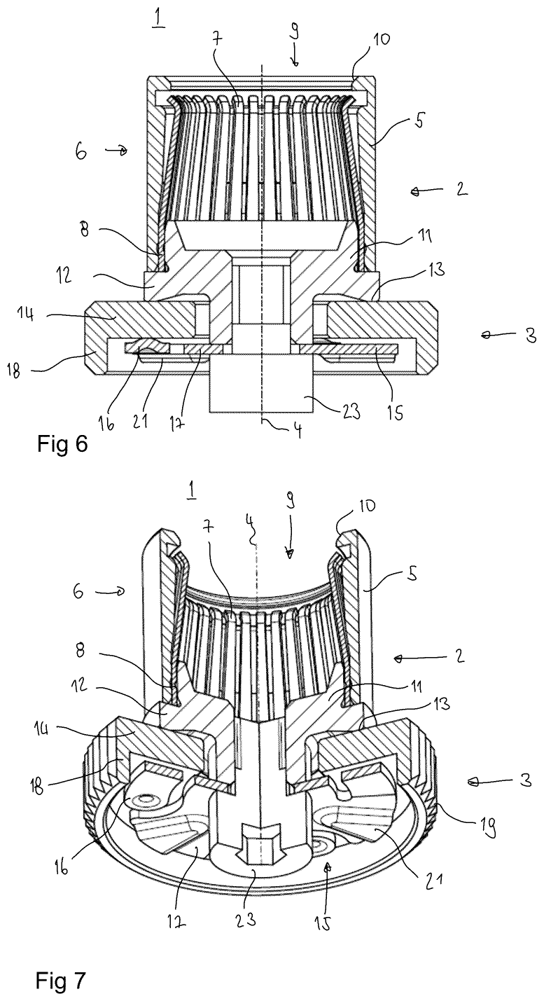

The side of the biasing member 15 of FIGS. 1 to 4 as well as FIGS. 6 and 7 that faces the floating ring 14 is shown in FIG. 5. The biasing member 15 comprises of a base plate 17 and three biasing elements 16 at its outer rim, which biasing elements 16 are integral with the base plate 17. Moreover, the base plate 17 is provided with three V-shaped corrugations 21 to improve its stiffness.

The biasing elements 16 take the form of tongues the longitudinal extension of which is in a circumferential direction of the biasing member 15. The tongues are located at the outer rim of the base plate 17. On the side that faces the floating ring 14, each tongue is provided with a domed pressing-on point 22 with which the biasing element 16 extends towards the floating ring 14. In an alternative embodiment (not shown in the Figures) the tongues lack the domed press-on points 22 and instead contact the floating ring 14 with the round (in the plane of the tongue as shown in the Figures) edges of their free ends.

FIGS. 6 and 7 show a variation of the connector of FIGS. 1 and 2, in which the biasing member 15 is fixed to the mating component's 2 inner cylinder 11 by means of a screw 23 rather than by flanging.

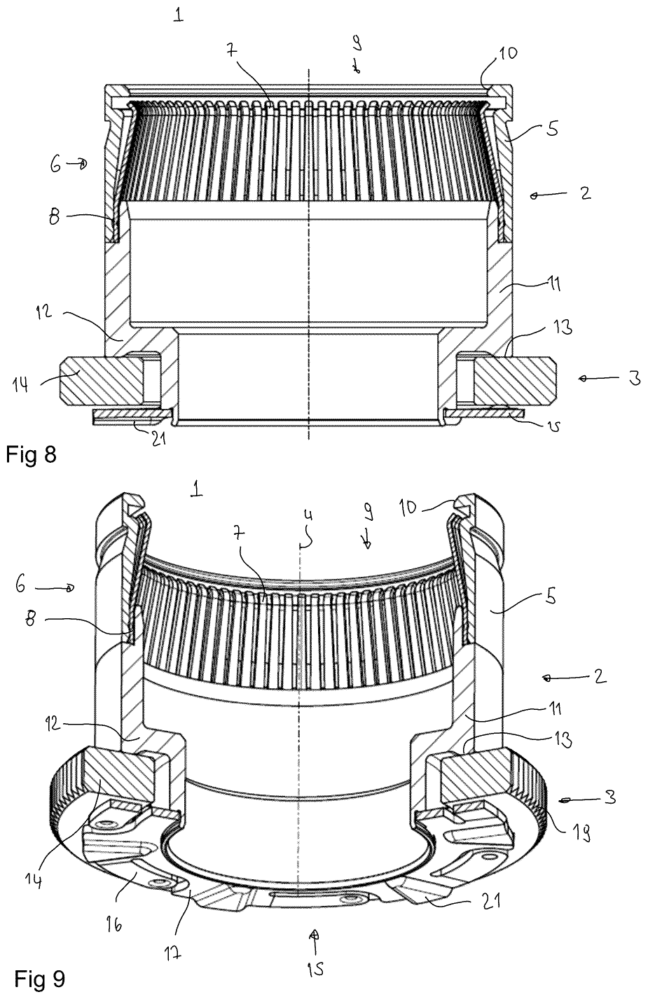

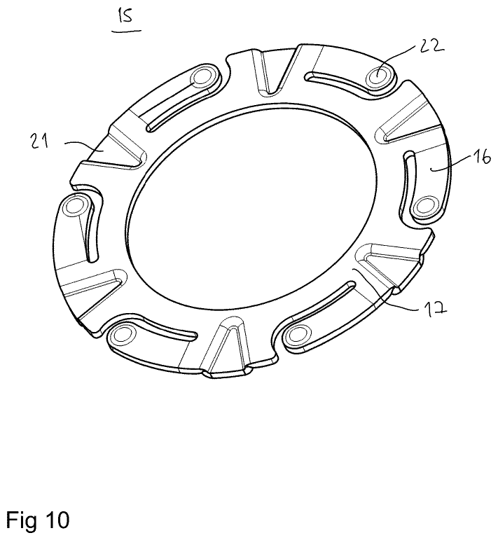

The connector 1 according to the invention can be adapted in its various dimensions according to the requirements of specific applications, for example the dimensions of a matching connector (not shown) to mate with. This is exemplified in FIGS. 8 and 9, which show a variant of the connector 1 of FIGS. 3 and 4 with larger diameters and without a cylindrical part. The side of the biasing member 15 of FIGS. 8 to 9 that faces the floating ring 14 is shown in FIG. 10. This biasing member 15 differs from that shown in FIG. 5 that due to its larger diameter the base plate 17 can now hold six rather than only three tongues 16 and is provided with six rather than only three V-shaped corrugations 21 to improve stiffness.

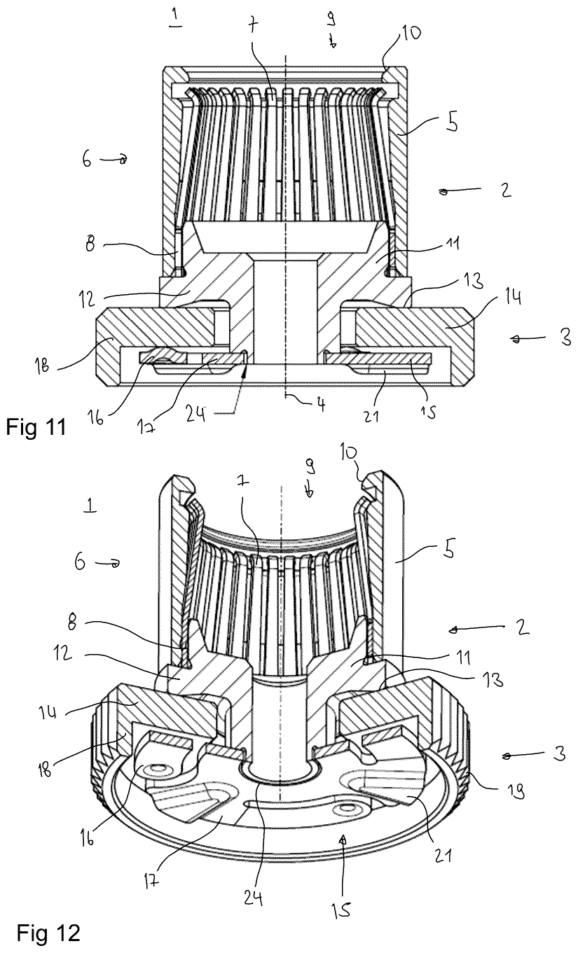

The variant of the connector 1 of FIGS. 1 and 2 shown in FIGS. 11 and 12 differs from the former variant in that biasing member 15 at the inner rim of its base plate 17 is fixed to the mating element's inner cylinder 11 by welding 24, for example laser welding, rather than flanging.

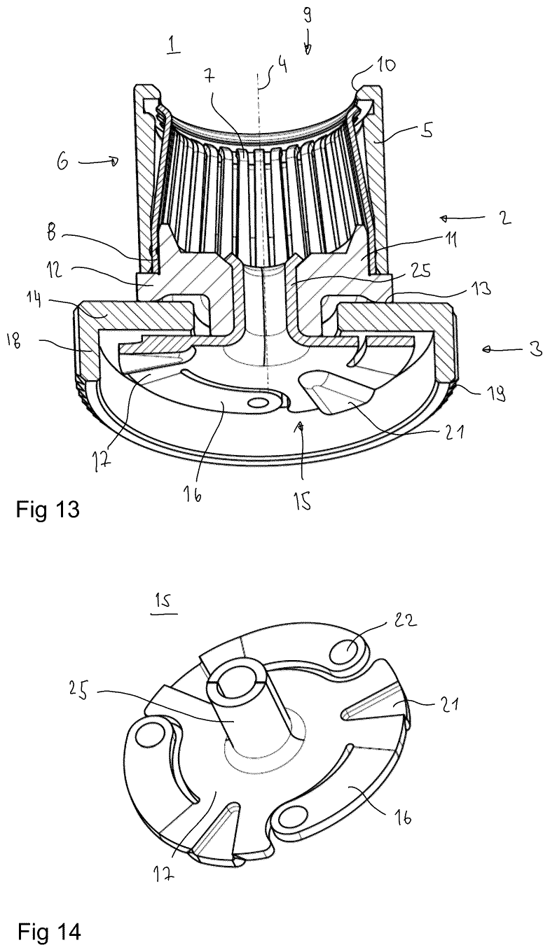

FIG. 13 shows a further variant of the connector 1 of FIGS. 1 and 2, in which the biasing member 15 comprises a cylindrical collar 25 that extends from the inner rim of the base plate 17 and is integral with the base plate 17. As can best be seen in FIG. 14, the collar 25 extends in or through the inside of the one component's inner cylinder 11 and at its end is flanged to fix it securely to the inner cylinder 11.

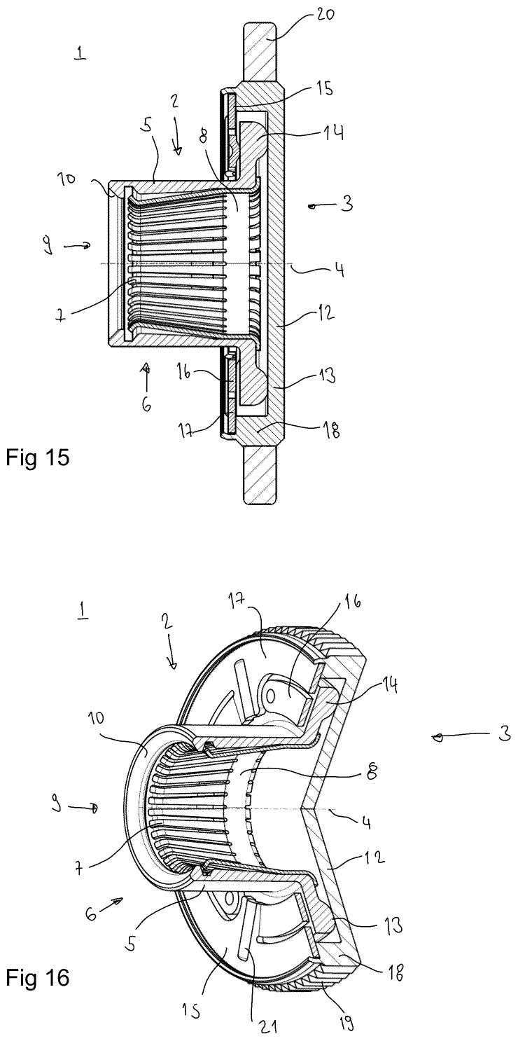

The connector 1 shown in FIGS. 15 and 16 differs from those connectors 1 discussed in the previously examples, in particular the example of FIGS. 1 and 2, in that the floating ring 14 is now part of the mating component 2 while the bearing 12 and the biasing member 15 are parts of the mounting component 3. The floating ring 14 at its inner edge leads into and is integral with the housing 5 of the mating component's 2 mating part 6. The cylindrical part 18 of the mounting component 3 is integral with the bearing 12, which now is a circular disc and closes off the cylindrical part 18 that is opposite the mating part 6 of the connector 1.

The side of the ring-shaped biasing member 15 of FIGS. 15 and 16 that faces the floating ring 14 is shown in FIG. 18. It differs from the one shown in FIGS. 5 and 10 in that there are now five rather than only three biasing elements 16 and that the biasing elements 16 are now at the inner rim of the base plate 17. The base plate 17 is fixed at its outer rim to the mounting component 3, again by flanging. The corrugations 21 for stiffening the base plate are now linear rather than V-shaped.

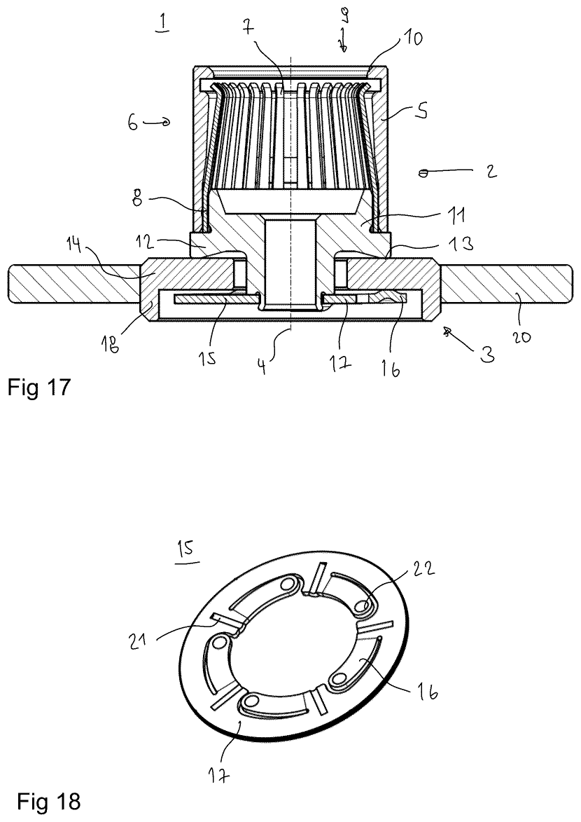

FIG. 15 also shows how, with its knurled rim 19, the mounting part 3 is mounted in a hole of a conductor rail 20. Similarly, in FIG. 17 it is shown how the connector 1 of FIGS. 1 and 2 is mounted in a hole of a conductor rail 20.

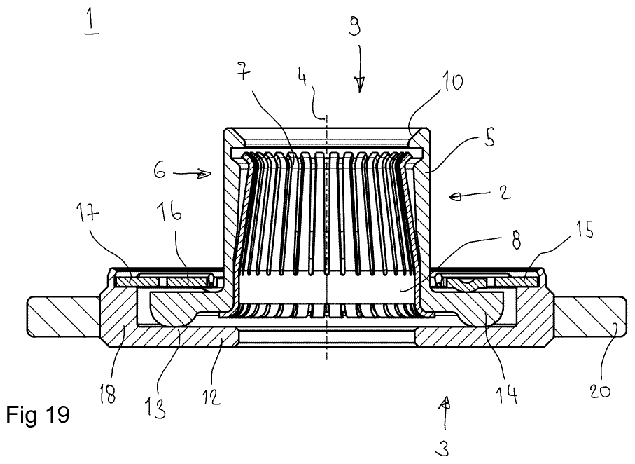

The connector 1 of FIG. 19 differs from the one shown in FIGS. 15 and 16 in that the bearing 12 is not disk-shaped but annular. As a result, rather than through opening 9, the pin of a counter connector can be plugged in from the side opposite of the opening 9 through the aperture of the annular bearing 12;

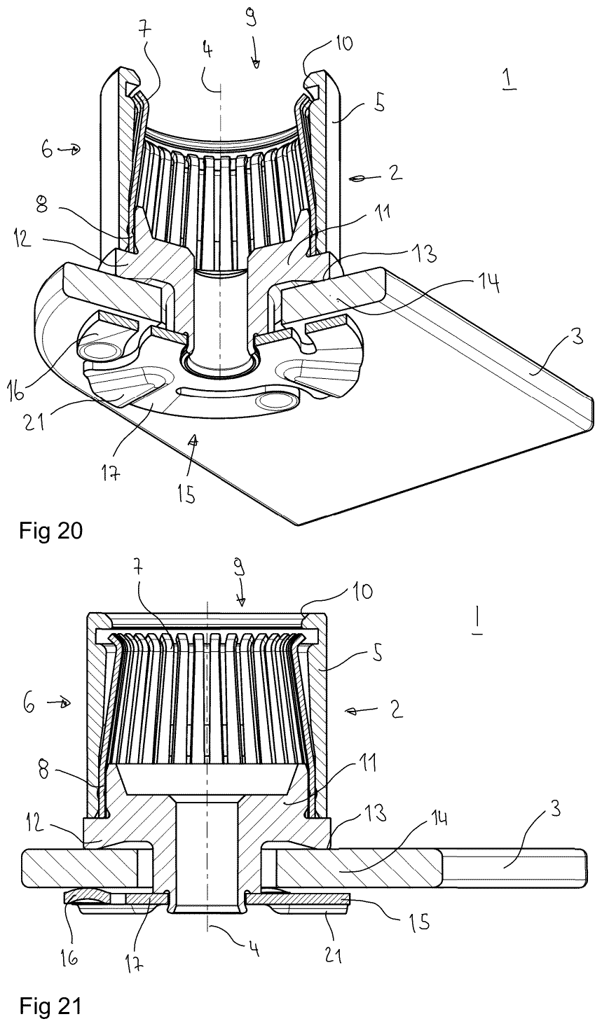

In FIGS. 20 and 21 it is shown how a conductor rail can serve as the mounting component 3, including the floating ring 14, doing away with the need for a separate mounting component. Both the bearing 12 and the press-on points 22 contact the part of the conductor rail that serves as the floating ring. Apart from that, the concept of the connector is similar to that of FIGS. 8 and 9 in that it lacks the cylindrical part 18. The inner cylinder 11 of the mating part is flanged outward to securely fix the biasing member 15 to the inner cylinder 11 of the mating component 2.

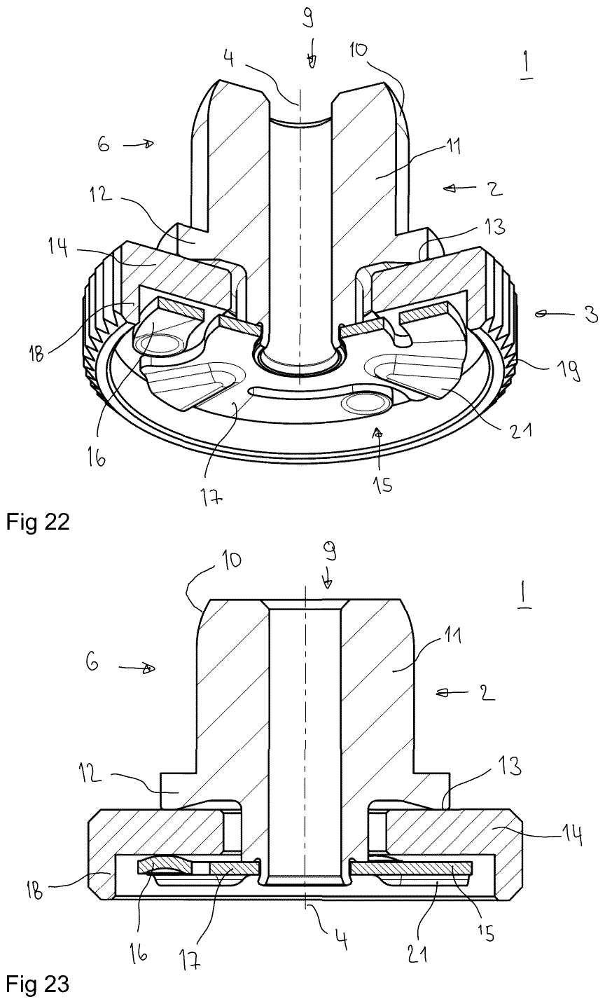

FIGS. 22 and 23 show an example of a connector 1 with a male rather than a female mating part 6. The male mating part 6 is a mating pin and the lead-in chamfer 10 is on the outside of the distal end of the pin. The pin is hollow and formed in one piece, ie, integral, with the inner circular cylinder 11 and the bearing 12. There is no housing 5.

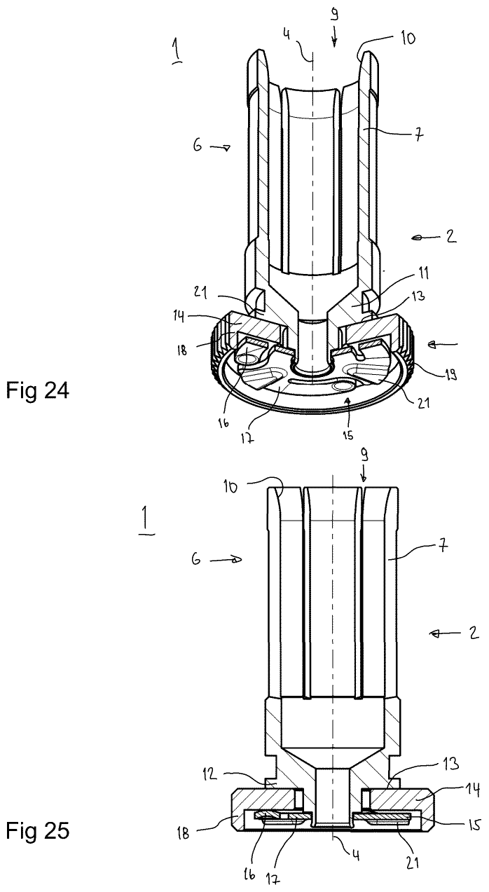

The connector of FIGS. 24 and 25 has a female mating part 6, which, however, comprises of a slotted bushing for a pin contact. Similar to the pin of FIGS. 22 and 23, the bushing is formed in one piece with the inner circular cylinder 11 and the bearing 12, and there is no housing 5.

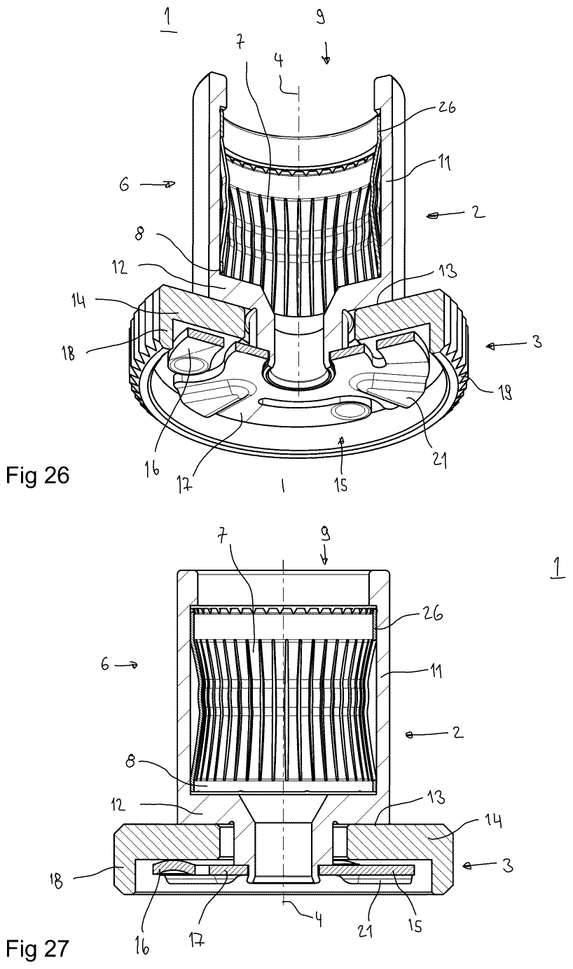

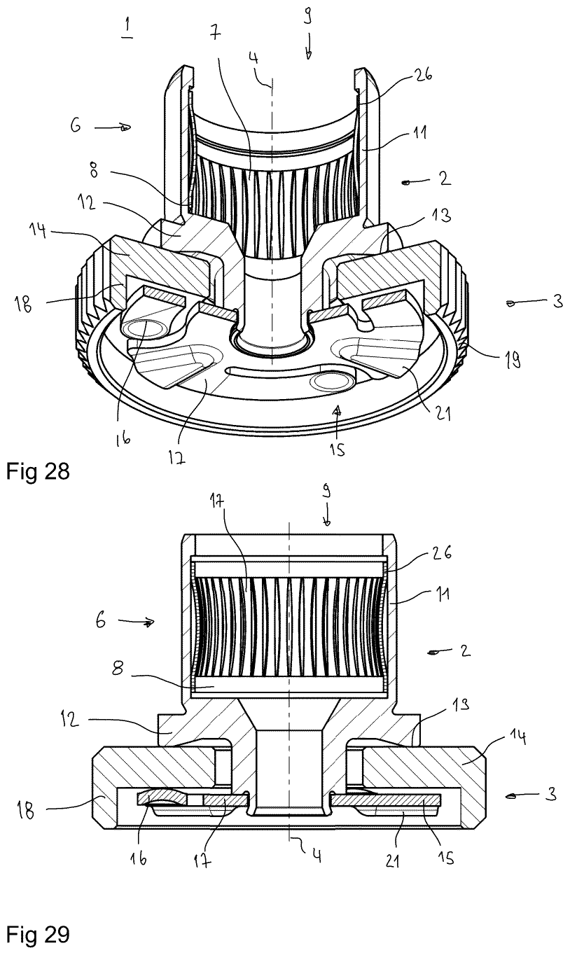

While the lamella baskets of the connectors 1 in FIGS. 1 to 21 are one-sided in the sense that lamellae 7 extend from the ring-shaped metal strip 8 only on one side while their other ends are open, the lamella basket of the connectors in FIGS. 26 and 27 is two-sided in the sense that the lamellae 7 extend between ring-shaped metal strips 8, 26 on both ends. Moreover, the lamellae 7 are generally W-shaped. This shape provides each lamella with two potential point to contact a counter connector introduced into the mating part 6. In contrast, the lamellae of the otherwise similar connector 1 of FIGS. 28 and 29 are U-shaped, providing each lamella with one designated potential point to contact a counter connector introduced into the mating part 6.

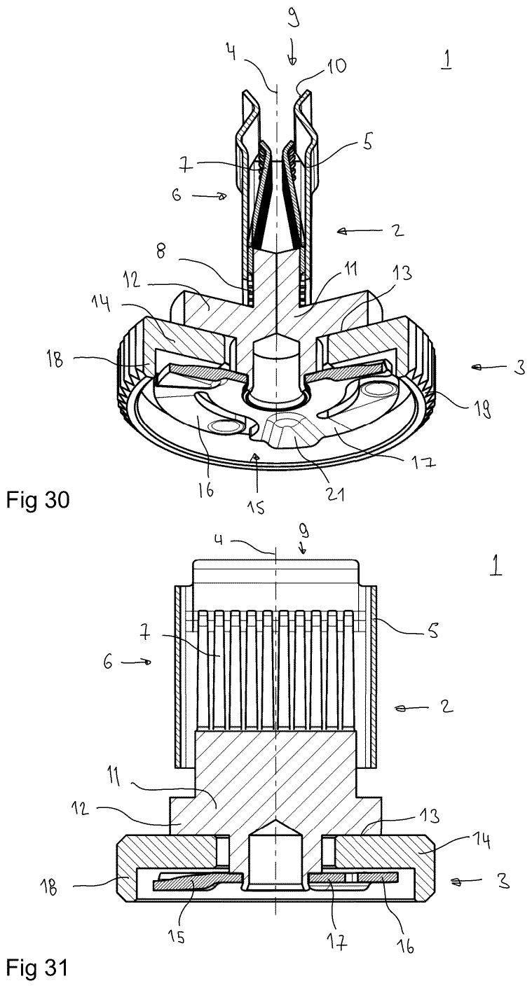

Finally, FIGS. 30 and 31 show an oblique sectional side view of a twelfth embodiment of the invention in which the mating part comprises flat bushing. This version can be plugged in with blade contact or directly with a conductor bar. The flat bushing has two parallel straight lamella combs, and the lamellae 7 of each lamella comb extend from a metal strip and have an open end. A sheet metal frame with insertion opening 9 serves as a housing 7 to support and protect the lamellae 7.

The features as described in the above description, claims and figures can be relevant individually or in any combination to realise the various embodiments of the invention.

### REFERENCE NUMERALS

1 floating electrical connector
2 mating component
3 mounting component
4 cylindrical axis
5 housing
6 mating part
7 elastic metal lamellae
8, 26 metal strip
9 opening
10 lead-in chamfer
11 inner circular cylinder
12 bearing
13 contact surface
14 floating ring
15 biasing member
16 biasing element
17 base plate
18 cylindrical part
19 outer surface, knurl
20 conductor rail
21 reinforcement, corrugation
22 press-on point
23 screw
24 laser welding
25 cylindrical collar

1. A floating electrical connector comprising a mounting component and a mating component that is movable relatively to the mounting component, wherein one component of the group of components comprising the mating component and the mounting component has a bearing and at least one elastic biasing element, wherein the other component of the group of components comprising the mating component and the mounting component has a floating ring that extends into a gap between the biasing element(s) and the bearing, and wherein the biasing element(s) bias the floating ring against the bearing, wherein the biasing elements(s) are fixed to the one component.

2. The floating electrical connector of claim 1, wherein the biasing element(s) is/are tongue(s).

3. A floating electrical connector comprising a mounting component and a mating component that is movable relatively to the mounting component, wherein one component of the group of components comprising the mating component and the mounting component has a bearing and at least one elastic biasing element, wherein the other component of the group of components comprising the mating component and the mounting component has a floating ring that extends into a gap between the biasing element(s) and the bearing, and wherein the biasing element(s) bias the floating ring against the bearing, wherein the biasing element(s) is/are tongue(s).

4. The floating electrical connector of claim 1, wherein at least one of the biasing element(s) comprises a press-on point for pressing on the floating ring, which press-on point is convexly domed, or a press-on surface for pressing on the floating ring, the edges of which press-on surfaces are convexly rounded.

5. The floating electrical connector of claim 1, wherein the biasing element(s) are part of a biasing member that comprise a base plate with a base surface facing the floating ring, and the biasing element(s) extending outside the base surface towards the floating ring to press against the floating ring.

6. The floating electrical connector of claim 5, wherein the biasing element(s) are integral with the base plate.

7. The floating electrical connector of claim 5, wherein the biasing member is formed by punching, stamping, cutting deep-drawing or a combination thereof.

8. The floating electrical connector of claim 5, wherein the base plate comprises reinforcements for stiffening the base plate.

9. The floating electrical connector of claim 5, wherein the base plate is fixedly attached to the one component, directly or indirectly, at an inner rim of the base plate.

10. The floating electrical connector of claim 5, wherein the base plate is fixedly attached to the one component, directly or indirectly, at an outer rim of the base plate.

11. The floating electrical connector of claim 1, wherein the biasing element(s) are electrically conducting.

12. The floating electrical connector of claim 1, wherein the mating direction of the mating component and the pressing-on direction are essentially aligned.

13. The floating electrical connector of claim 1, wherein the mating component comprises a lamella comb, a slotted sleeve or a slotted pin.

14. The floating electrical connector of claim 1, wherein the mating component is a female mating component for mating with a male mating component of a counter connector, or the mating component is a male mating component for mating with a female mating component.

15. The floating electrical connector of claim 1, wherein the one component is the mating component.
